(19) United States
(12) Patent Application Publication
(10) Pub. No.: US 2020/0369216 A1
(43) Pub. Date: Nov. 26, 2020

(54) BIKE CARRIER

(71) Applicant: THULE SWEDEN AB, Hillerstorp (SE)

(72) Inventors: Stefan ALMHILL, Taberg (SE); Peter KARLSSON, Halmstad (SE)

(21) Appl. No.: 16/961,151

(22) PCT Filed: Jan. 11, 2019
(86) PCT No.: PCT/EP2019/050709

§ 371 Date: Jul. 9, 2020

(30) Foreign Application Priority Data
Feb. 7, 2018 (EP) 18155452.8

(51) Int. Cl. B60R 9/10; B60R 9/06; B60D 1/06

(52) U.S. Cl. CPC B60R 9/10; B60D 1/06; B60R 9/06

(57) ABSTRACT

A bike carrier mountable on a trailer coupling is disclosed. The bike carrier comprises two support arms arranged pivotably between a non-use position and a use position and two primary supporting devices each having a movable receiving member and configured to clamp a coupling body of a trailer coupling therebetween. The support arms are operatively coupled with the primary supporting devices such that a movement of the support arms effects a movement of the receiving members. The bike carrier further comprises a secondary supporting device configured to engage with a protrusion provided on the neck of the trailer coupling.

### FIELD OF THE INVENTION

The present invention relates to a bike carrier mountable on the trailer coupling of a vehicle.

### BACKGROUND

Bike carriers that are mountable on the trailer coupling of a vehicle have become increasingly popular. Such bike carriers are usually coupled to the trailer coupling by clamping a coupling body of the trailer coupling such as a ball head. Coupling mechanisms used in this regard are often complex and the load applied on the trailer coupling is transferred via the ball head to a great extent limiting the load to be transported.

### SUMMARY

It is the object of the invention to provide an easy to mount bike carrier with increased stability on a vehicle trailer coupling and with increased load capacity.

The object is solved by a load carrier according to claim 1. Advantageous further formations are subject of the dependent claims.

According to the present disclosure a bike carrier is disclosed. The bike carrier is mountable on a trailer coupling comprising a neck, a coupling body supported by the neck, and at least one protrusion provided on the neck.

In the context of the present disclosure, a trailer coupling is to be understood as a coupling device mounted on the rear of a vehicle and allowing to releasably couple load carriers of different kinds thereon. Such a coupling device can be configured to allow coupling and towing trailers. The trailer coupling comprises a neck and a coupling body. The neck can comprise a vehicle side end configured to mount the trailer coupling to the vehicle. The other end of the neck is coupled to the coupling body and supports the same. The neck can comprise a curved shape.

A protrusion is provided on the neck. The protrusion is configured to provide an additional support section on the trailer coupling in addition to the coupling body. The protrusion can have a shape allowing an engagement therewith. Such an engagement is preferably a positive fit engagement also referred to as form fit engagement. In such an engagement, the protrusion blocks a movement of a member engaged therewith in more than one direction. The protrusion can be integrally formed with the neck.

For example, the neck and the protrusion can be integrally formed by molding. It is also possible to bond the protrusion to the neck. This can be done by welding, for instance. It is also possible to fixedly mount the protrusion to the neck without joining the protrusion and the neck on an atomic or molecular basis. The protrusion can extend in a direction which is substantially perpendicular to the extension direction of the trailer coupling and in particular such that the protrusion extends in horizontal direction and perpendicular to the longitudinal direction of a vehicle on which the trailer coupling is mounted.

The bike carrier comprises two support arms arranged pivotably between a non-use position and a use position. In the context of the present disclosure a use position is to be understood as a position taken by the support arms when the bike carrier is fixedly mounted on the trailer coupling and ready for supporting bikes thereon. The support arms can be part of a support frame of the bike carrier and transfer a load from a portion of the bike carrier on which a bike is supported. The support arms can be tubes made from aluminum, for instance.

Furthermore, the bike carrier comprises two primary supporting devices each having a movable receiving member configured to clamp the coupling body of the trailer coupling therebetween. The support arms are operatively coupled with the primary supporting device such that a movement of the support arms effects a movement of the receiving members. For example, the support arms can be directly coupled to the primary supporting devices or receiving members so that the primary supporting device or receiving member is integrally movable with the support arm to which it is coupled. The receiving member can be clipped or inserted on a support arm. In addition or in the alternative, the receiving member can be fixed on a support arm.

Furthermore, the bike carrier comprises a secondary supporting device configured to engage with the protrusion. The secondary supporting device can be configured such that an engagement with the protrusion takes place at a predetermined distance from an engagement or clamping with the coupling body. In the context of the present disclosure, an engagement between the secondary supporting device and the protrusion is established when the secondary supporting device at least accommodates a portion of the protrusion or vice versa. In this way, a movement of the accommodated element beyond a predetermined distance is blocked or prevented in more than one direction. It is to be noted that accommodated does not mean that the elements are in contact with each other. There can be a gap between the elements that are engaged with each other. However, the secondary supporting device and the protrusion are preferably configured such that such a gap is as small as possible and a movement is substantially completely blocked in a specific direction.

The receiving members are preferably movable between an open position in which the receiving members are arranged such that the coupling body is arrangeable between the two receiving members and an engaging position in which each of the two receiving members is arranged such that the receiving members contact an inserted coupling body, preferably from opposite sides.

Preferably, each receiving member is pivotably movable about a pivot axis. For example, the receiving members can be pivotably movable about a single pivot axis.

Preferably, a first receiving member of the receiving members is pivotably movable about a first pivot axis and a second receiving member of the receiving members is pivotably movable about a second pivot axis. Preferably, the pivot axes are arranged parallel with respect to each other.

Preferably, the secondary supporting device comprises at least one engaging member movable towards and away from the protrusion. Preferably, the engaging member comprises a recess or opening allowing an engagement with the protrusion by pivotably passing the engaging member over or on at least a portion of the protrusion.

Preferably, the protrusion is at least partially formed as a solid of revolution protruding from the neck. For example, the protrusion can be formed as a cylindrical pin or frusto-conical pin. Alternatively, the protrusion can comprise an oval or rectangular pin. The recess or opening can comprise an inner contour which at least partially follows an outer contour of the protrusion. The engaging member comprises a base plate in which the recess is formed. The recess can be formed in a U-shaped manner. The base plate can be coupled to the receiving member at one end and the recess can be provided in the opposite end.

The recess or opening extends in the engaging member in an extension direction which is substantially perpendicular to the pivot axis of the engaging member in which the recess or opening is provided. In the mounted state of the bike carrier, the pivot axis of the engaging member extends substantially in longitudinal direction of the vehicle and of the trailer coupling. As mentioned above, the protrusion can extend horizontally and perpendicular to a longitudinal direction of a vehicle on which the trailer coupling is mounted.

By pivoting the engaging member about the pivot axis, the recess or opening approaches the protrusion from above and is pivoted along the extension direction of the protrusion. In other words, the engaging member is not only radially moved towards the protrusion but also along the extension direction of the protrusion. The extension direction can be the extension direction in longitudinal direction of the protrusion. In case the protrusion comprises the shape of a solid of revolution, the extension axis can be the axis of revolution. The protrusion can have the shape of a right circular cylinder.

Preferably, the secondary supporting device, for example an engaging member thereof, comprises a supporting surface arranged substantially perpendicular to a movement direction of the secondary supporting device and configured to contact an abutment surface provided on the neck. For example, when the engaging member is pivotably arranged about a pivot axis, the supporting surface can be arranged parallel to the pivot axis or such that the pivot axis and the supporting surface lie in the same plane. An engaging member with such a supporting surface adds additional stability when the bike carrier is mounted on the trailer coupling and the supporting surface contacts the abutment surface on the neck.

The abutment surface can be a flat surface at least partially encircling the protrusion. For example, the abutment surface can be provided at a base portion of the protrusion, i.e. at a junction between protrusion and neck. In case the protrusion is a cylindrical pin protruding from the neck, the abutment surface can be a ring-like surface which extends substantially perpendicular to the lateral surface of the cylindrical pin. The abutment surface can be provided adjacent the protrusion or can be arranged on the neck at a predetermined distance from the protrusion.

Preferably, one of the primary supporting devices and the secondary supporting device are coupled to each other. For example, the primary supporting device and the secondary supporting device can be rigidly coupled to each other. The primary supporting device and the secondary supporting device can be integrally formed with each other, preferably by molding.

Preferably, one engaging member is integrally formed with one of the receiving members. For example, the engaging member can be integrally molded or cast with the receiving member. As an alternative, the engaging member can be integrally formed with one of the receiving members by welding. The receiving members preferably comprise reinforcing walls. The combination of a receiving member and an engaging member can also be referred to as coupling member.

Preferably, the support arms are integrally movably coupled with the primary supporting devices, for example with the receiving members. For example, the receiving members can be screwed onto an end of the support arms.

Preferably, the coupling body comprises a ball head and the receiving members comprise a bowl shape with an inner surface configured to contact the ball head. Preferably, the inner surface is configured to contact only a spherical zone of the ball head.

Preferably, at least one engaging member comprises a fork-like shape with two prongs defining an accommodating space between them for at least partially accommodating one of the protrusions.

Preferably, the receiving members and the engaging members are arranged such that in a condition in which the bike carrier is mounted on a trailer coupling of a vehicle, an operating position of the receiving member is offset with respect to an operating position of the engaging members in a longitudinal direction of the vehicle. In the context of the present disclosure, the operating position of the receiving member can be regarded as a position in which the receiving member is located at a longitudinal position in which a vertical line intersects with the center of the ball head. The operating position of the engaging members can be a position in which the engaging members are located at a longitudinal position in which a vertical line intersects with the center of the protrusion. The distance between both vertical lines can be regarded as the above mentioned offset.

Preferably, the two support arms are pivotably mounted on a base part at a distance from each other and such that shorter portions of the support arms are provided on one side of the base part and longer portions of the support arms are provided on the other side of the base part. The receiving members can be coupled to the shorter portions of the support arms.

Preferably, the bike carrier further comprises a tensioning mechanism configured to urge the two support arms into the use position upon operation of the same. Preferably, the tensioning mechanism is further configured to lock the two support arms in the use position.

Preferably, the tensioning mechanism and the receiving members are arranged on opposite sides of the base part. Alternatively or in addition, a bike support portion can be provided on each longer portion of the support arms.

### BRIEF DESCRIPTION OF THE DRAWINGS

FIG. 1 shows a perspective view of a bike carrier mounted on a trailer coupling.

FIG. 2 shows a perspective rear view of a coupling member of the bike carrier of FIG. 1.

FIG. 3 shows a perspective front view of a coupling member of the bike carrier of FIG. 1.

FIG. 4 shows a front view of the trailer coupling of FIG. 1.

FIG. 5 shows a side view of the trailer coupling of FIG. 1.

FIG. 6 shows a side view of the trailer coupling of FIG. 1 with a bike carrier mounted thereon.

FIG. 7 shows a perspective view of the bike carrier in a stowing state.

FIG. 8 shows a perspective view of the bike carrier in an intermediate mounting state.

FIG. 9 shows a perspective view of the bike carrier in a state in which it is mounted on the trailer coupling of a vehicle.

### DETAILED DESCRIPTION OF EMBODIMENTS

In the following, an embodiment as well as modifications of the present subject matter will be described with reference to the drawings. It is to be noted that similar elements in the drawings are denoted with the same reference signs.

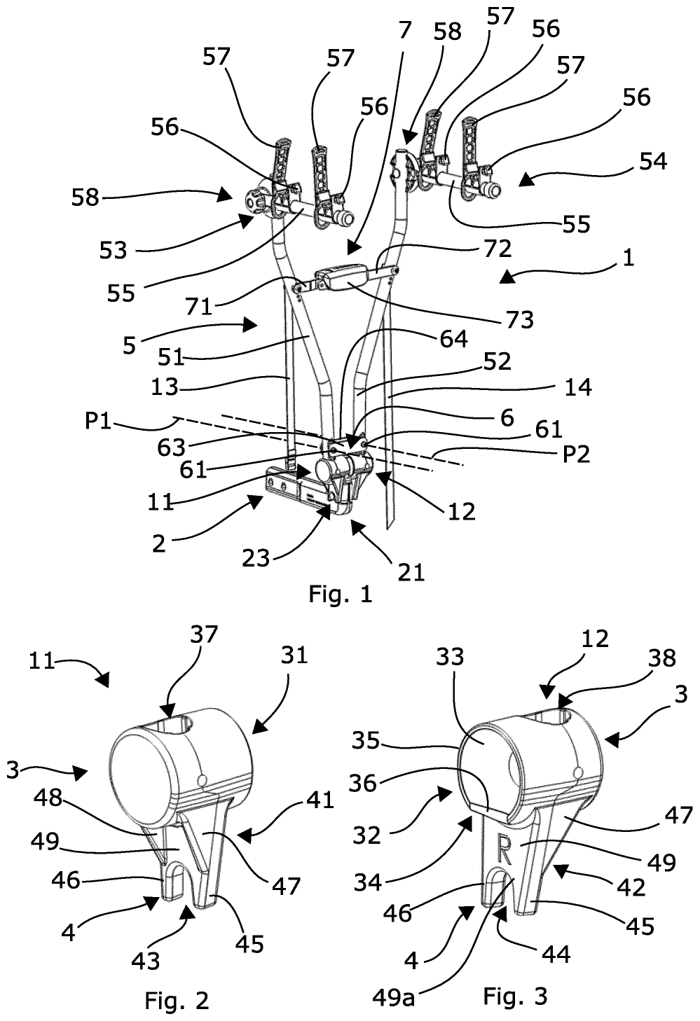

FIG. 1 shows a bike carrier 1 in a perspective view. In the shown state, the bike carrier 1 is mounted on a trailer coupling 2 of a vehicle (not shown in FIG. 1).

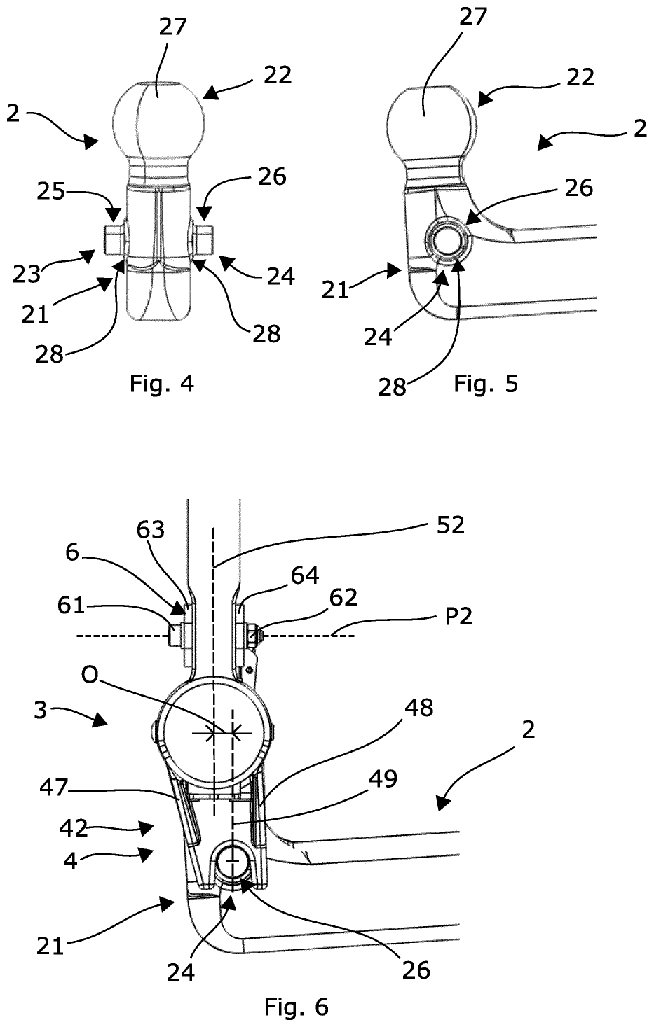

The trailer coupling 2 is shown in FIGS. 4 and 5 and comprises a neck 21, a coupling body 22 embodied as a ball head 27 and supported by the neck 21, and protrusions 23, 24 embodied as cylindrical pins 25, 26 protruding from the neck 21 on opposite sides and at a predetermined distance from the ball head 27. The cylindrical pins 25, 26 are integrally formed with the neck 21 and are formed on the neck so as to extend in horizontal direction when the trailer coupling 2 is mounted on the rear of a vehicle.

The bike carrier 1 comprises two support arms 51, 52 forming a part of a foldable support frame 5 of the bike carrier 1. The two support arms 51, 52 are pivotably coupled to a base part 6.

The base part 6 comprises two substantially flat metal plates 63, 64 arranged at a distance from each other. The two support arms 51, 52 are accommodated between the flat metal plates 63, 64. More precisely, each support arm 51, 52 is pivotably held on the base part 6 by means of threaded bolts 61 that are passed through the base part 6 and the respective support arm 51, 52 and fixed by nuts (not shown in FIG. 1). One of the nuts 62 is visible in FIG. 6 which will be described later in greater detail.

The threaded bolts 61 define respective pivot axes P1, P2 of the support arms 51, 52. The left arm 51 is pivotable about pivot axis P1 and the right arm 52 is pivotable about pivot axis P2. As is further shown in FIG. 1, the pivot axes P1, P2 are parallel with respect to each other and extend in longitudinal direction of the trailer coupling 2. The longitudinal direction of the trailer coupling 2 corresponds to the longitudinal direction of a vehicle on which the trailer coupling is mounted. Accordingly, the pivot axes P1, P2 extend in the longitudinal direction of the vehicle when the bike carrier is mounted on the trailer coupling 2.

The support arms 51, 52 are mounted on the base part 6 such that a longer portion of the support arms 51, 52 is arranged on one side of the base part 6 and a shorter portion of the support arms 51, 52 is arranged on the opposite side of the base part 6. In the present configuration, the support arms 51, 52 are aluminum tubes but other configurations of the support arms are possible as well. The longer portion of the support arms 51, 52 also forms an upper portion of the support arms 51, 52 when the bike carrier 1 is in use, i.e. mounted on the trailer coupling 2.

At an end portion of the longer portion of the support arms, i.e. at an end portion of the upper portion of the support arms 51, 52, a respective bike support portion 53, 54 is mounted by means of a coupling mechanism 58. Each bike support portion 53, 54 comprises a support bar 55 which is substantially straight and comprises an aluminum tube in the present disclosure. Two frame holders 56 and two fixation straps 57 are provided on each support bar 55. Thus, the bike carrier 1 is configured to transport two bikes. The frame holders 56 are configured to support a portion of the frame of a bike thereon and the fixation straps 57 are configured to securely fix the portion of the bike frame accommodated in the frame holders 56. Each coupling mechanism 58 couples a support bar 55 of one of the bike support portions 53, 54 to the support arms 51, 52 in a foldable manner. In other words, the support bars 55 can be folded towards the support arms 51, 52 when the bike carrier 1 is to be stowed. In order to further secure bikes to be transported on the bike carrier 1 two straps 13, 14 are fixed on the support arms 51, 52, one on each support arm 51, 52.

The shorter portions of the support arms 51, 52, i.e. the lower portions of the support arms 51, 52 which are located below the base part 6 when the bike carrier is mounted on the trailer coupling 2, comprise coupling members 11, 12. The coupling members 11, 12 are configured to fixedly couple the bike carrier 1 to the trailer coupling 2. The coupling members 11, 12 are fixedly mounted on the lower portions of the support arms 51, 52 and are shown in greater detail in FIGS. 2 and 3. Thus, the coupling members 11, 12 are integrally movable with the lower portions of the support arms 51, 52 and thus moved in response to a movement of the upper portions of the support arms 51, 52. Accordingly, the support arms 51, 52 can be regarded as operating levers of the coupling members 11, 12.

A tensioning mechanism 7 is provided between the upper portions of the support arms 51, 52. The tensioning mechanism 7 comprises two bars 71, 72 hingedly coupled to each other at one portion and hingedly coupled to the support arms at another portion thereof. The bars 11, 12 can be brought into a tensioned state or rotated such that the positions where the bars are coupled to the support arms 51, 52 are arranged at maximum distance. The maximum distance is configured such that the coupling members 11, 12 are positioned at a desired minimum distance from each other such that a sufficiently high clamping force is generated on the trailer coupling 2. Thus, the state in which the above mentioned maximum distance is achieved can also be referred to as tensioned state or clamping state of the bike carrier 1. The tensioning mechanism 7 further comprises a locking member 73 which is configured to releasably lock the bars 71, 72 in the tensioned state.

The coupling members 11, 12 will now be described in greater detail with respect to FIGS. 2 and 3. Each coupling member 11, 12 comprises a primary supporting device 3 and a secondary supporting device 4. The primary supporting device 3 is configured so as to provide a support against the coupling body 22 in the form of a ball head 27 of the trailer coupling 2 as shown in FIGS. 4 and 5. The secondary supporting device 4 is configured so as to support the bike carrier 1 against a protrusion 23, 24 provided on the neck 21 of the trailer coupling 2, which in the present disclosure is exemplified in the form of cylindrical pins 25, 26 integrally formed on the neck 21 of the trailer coupling 2 as shown in FIGS. 4 and 5. As is also visible in FIGS. 4 and 5, the neck 21 comprises an abutment surface 28 extending perpendicular to an extension direction of the cylindrical pins 25, 26.

The primary supporting device 3 comprises a receiving member 31, 32. The shape of the receiving member 31, 32 is based on a cylindrical solid body. A recess with a curved inner surface 33 is provided in one axial end of the cylindrical solid body, more precisely in the axial end which is intended to face the ball head 27. The recess is shaped such that the ball head 27 can be partially accommodated therein with an edge 35 surrounding a segment of the ball surface of the ball head 27. The inner surface 33 is configured such that only a spherical zone of the ball head 27 is in contact with the inner surface 33 when the receiving member 31, 32 is in contact with the ball head 27. A further recess 34 is provided in the edge 35. This recess 34 is formed according to the shape of the neck 21 adjacent the ball head 27. A curved surface 36 of the recess 34 can be configured to contact the neck 21 in order to provide additional support. Furthermore, a mounting recess 37, 38 for accommodating an end portion of a support arm 51, 52 is provided and extends in radial direction of the receiving member 31, 32.

The secondary supporting device 4 is integrally formed with the primary supporting device 3 and comprises an engaging member 41, 42. More precisely, the secondary supporting device 4 is integrally molded with the receiving member 31, 32. The engaging member 41, 42 protrudes from the receiving member 31, 32 on a side which is opposite to the side in which the mounting recess 37, 38 is provided. In other words, in the mounted state of the bike carrier 1, the engaging member 41, 42 protrudes downward from the receiving member 31, 32. The engaging member 41, 42 comprises a recess 43, 44 which is configured to allow an engagement with the protrusion 23, 24.

The recess 43, 44 is formed in a base plate 49 in a U-shaped manner giving the engaging member 41, 42 the shape of a fork having two prongs 45, 46. The inner contour of the recess 43, 44 at least partially follows an outer contour of the receiving member 31, 32. Furthermore, the recess extends in the engaging member 41, 42 in an extension direction which is substantially perpendicular to the pivot axis P1, P2 when the coupling member 11, 12 is mounted on a support arm 51, 52. Thus, the extension direction of the recess 43, 44 is substantially perpendicular to the extension direction of the mounting recess 37, 38. Due to the construction of the secondary supporting device 4, it is possible to pivotably pass the engaging member 41, 42 over at least a portion of the protrusion 23, 24. The engaging member 41, 42 further comprises a supporting surface 49a arranged substantially perpendicular to a movement direction of the engaging member 41, 42. This supporting surface 49a is configured to contact the above described abutment surface 28 provided on the neck 21. When pivoting the engaging member 41, 42, the supporting surface 49a approaches the abutment surface 28 and can contact the same when the bike carrier 1 is mounted on the trailer coupling 2.

The receiving member 31, 32 and the engaging member 41, 42 are arranged such that in a condition in which the bike carrier 1 is mounted on a trailer coupling 2 of a vehicle, an operating position of the receiving member 31, 32 is offset by a distance O with respect to an operating position of the engaging member 41, 42 in a longitudinal direction of the trailer coupling 2 mounted on a vehicle as is shown in FIG. 6. In order to strengthen the engaging member 41, 42 reinforcing walls 47, 48 are arranged with one side coupled to the base plate 49 and the another side coupled with an outer surface of the primary supporting device 3.

With reference to FIGS. 6 to 8 it is described how the bike carrier 1 is mounted on the trailer coupling 2 of a vehicle 10.

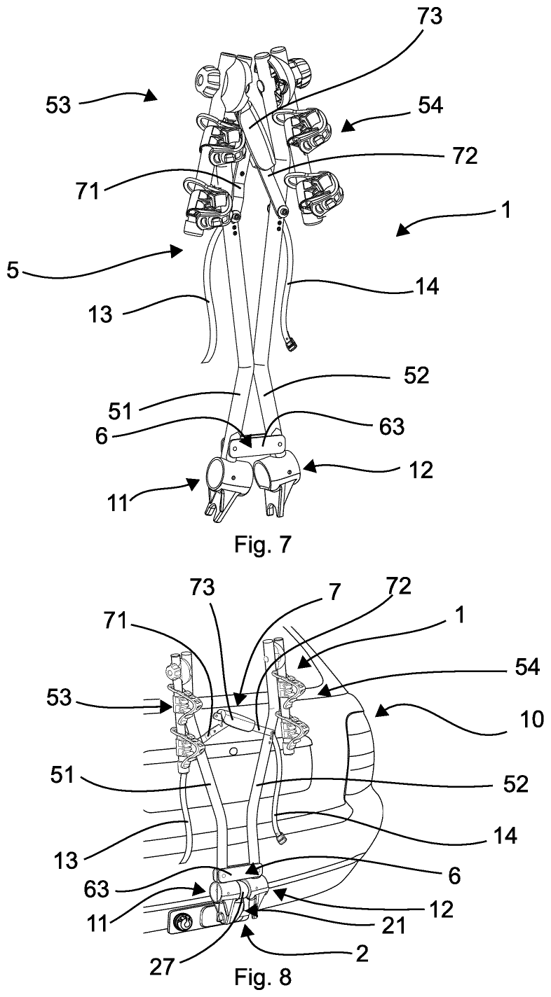

FIG. 7 shows a state in which the upper end portions of the support arms 51, 52 are folded against each other and brought into a non-use position. This state is also referred to as non-use state or stowing state as folding the support arms 51, 52 inward reduces the dimension of the bike carrier 1. In this state, the coupling members 11, 12 are positioned at a distance allowing to insert the ball head 27 of the trailer coupling between them. In this state, the bike carrier 1 is arranged on the ball head 27. After that, the upper portions of the support arms 51, 52 are moved away from each other to move the coupling members 11, 12 towards each other in order to engage them with the trailer coupling 2.

FIG. 8 shows a state in which the coupling members 11, 12 are brought into positions in which the ball head 27 is partially received in the receiving members 31, 32 and the engaging members 41, 42 are pivoted about pivot axes P1 and P2 into positions in which the cylindrical pins 25, 26 are arranged in the recesses of the engaging members 41, 42.

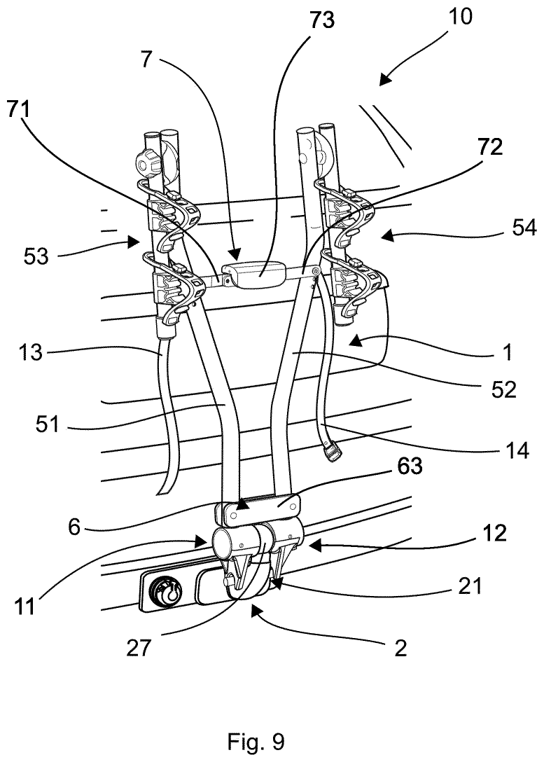

In FIG. 9, the tensioning mechanism 7 is brought into a tensioning state by moving the locking member 73 downward until the bars 71, 72 are arranged parallel with each other so that the upper portions of the support arms 51, 52 are arranged at maximum distance with respect to each other. The receiving members 31, 32 now firmly clamp the ball head 27 and the engaging members 41, 42 are engaged with the cylindrical pins 25, 26 with only a slight play between cylindrical pins 25, 26 and the walls of the recesses 43, 44.

### LIST OF REFERENCE SIGNS

1 Bike carrier
2 Trailer coupling
21 Neck
22 Coupling body
23, 24 Protrusion
25, 26 Cylindrical pin
27 Ball head
28 Abutment surface
3 Primary supporting device
31, 32 Receiving members
33 Inner surface
34 Recess
35 Edge
36 Surface
37, 38 Mounting recess
4 Secondary supporting device
41, 42 Engaging member
43, 44 Recess/opening
45, 46 Prongs
47, 48 Reinforcing wall
49 Base plate
49a Supporting surface
5 Support frame
51, 52 Support arms
53, 54 Bike support portion
55 Support bar
56 Frame holder
57 Fixation straps
58 Coupling mechanism
6 Base part
61 Threaded bolt
62 Nut
63, 64 Metal plates
7 Tensioning mechanism
71, 72 Bar
73 Locking member
10 Vehicle
11, 12 Coupling member
13, 14 Strap
P1, P2 Pivot axis

1.-15. (canceled)

16. A bike carrier mountable on a trailer coupling, said bike carrier comprising:
two support arms arranged pivotably between a non-use position and a use position;
two primary supporting devices each having a movable receiving member, wherein said support arms are operatively coupled with said primary supporting devices such that a movement of said support arms effects a movement of said receiving members,
wherein each receiving member is configured to clamp a coupling body, supported by a neck of said trailer coupling, and
wherein said bike carrier further comprises a secondary supporting device configured to engage with at least one protrusion provided on said neck of said trailer coupling.

17. The bike carrier according to claim 16, wherein said receiving members are movable between an open position in which said receiving members are arranged such that said coupling body is arrangeable between said two receiving members and an engaging position in which each of said two receiving members is arranged such that said receiving members contact an inserted coupling body.

18. The bike carrier according to claim 16, wherein each receiving member is pivotably movable about a pivot axis.

19. The bike carrier according to claim 16, wherein a first receiving member of said receiving members is pivotably movable about a first pivot axis and a second receiving member of said receiving members is pivotably movable about a second pivot axis.

20. The bike carrier according to claim 16, wherein said secondary supporting device comprises at least one engaging member movable towards and away from said protrusion, wherein said protrusion comprises a cylindrical, oval, or rectangular pin and wherein said engaging member comprises a recess or opening allowing an engagement with said protrusion by pivotably passing said engaging member over at least a portion of said protrusion.

21. The bike carrier according to claim 20, wherein said protrusion is at least partially formed as a solid of revolution protruding from said neck, and wherein said recess or opening comprises an inner contour which at least partially follows an outer contour of said solid of revolution.

22. The bike carrier according to claim 20, wherein said recess or opening extends in said engaging member in an extension direction which is substantially perpendicular to a pivot axis of said engaging member in which said recess or opening is provided.

23. The bike carrier according to claim 20, wherein said secondary supporting device comprises a supporting surface arranged substantially perpendicular to a movement direction of said secondary supporting device and configured to contact an abutment surface provided on said neck.

24. The bike carrier according to claim 16, wherein one of said primary supporting devices and said secondary supporting device are rigidly coupled to each other or integrally formed with each other, wherein one engaging member is integrally formed with one of said receiving members, wherein said receiving members comprise reinforcing walls.

25. The bike carrier according to claim 16, wherein said support arms are integrally movably coupled with said primary supporting devices.

26. The bike carrier according to claim 16, wherein said coupling body comprises a ball head and said receiving members comprise a bowl shape with an inner surface configured to contact only a spherical zone of said ball head.

27. The bike carrier according to claim 20, wherein at least one engaging member comprises a fork-like shape with two prongs defining an accommodating space between them for at least partially accommodating one of said protrusions.

28. The bike carrier according to claim 20, wherein said receiving members and said engaging members are arranged such that in a condition in which said bike carrier is mounted on a trailer coupling of a vehicle, an operating position of said receiving member is offset with respect to an operating position of said engaging members in a longitudinal direction of the vehicle.

29. The bike carrier according to claim 16, wherein said two support arms are pivotably mounted on a base part at a distance from each other and such that shorter portions of said support arms are provided on one side of said base part and longer portions of said support arms are provided on the other side of said base part, wherein said receiving members are coupled to said shorter portions of said support arms.

30. The bike carrier according to claim 29, further comprising a tensioning mechanism configured to urge said two support arms into said use position upon operation of the same or wherein said tensioning mechanism and said receiving members are arranged on opposite sides of said base part or wherein a bike support portion is provided on each longer portion of said support arms.

31. The bike carrier according to claim 19, wherein said pivot axes are arranged parallel with respect to each other.

32. The bike carrier according to claim 23, wherein said abutment surface is a flat surface at least partially encircling said protrusion.

33. The bike carrier according to claim 30, wherein said tensioning mechanism is configured to lock said two support arms in said use position.
